(19) United States
(12) Patent Application Publication
(10) Pub. No.: US 2005/0118433 A1
(43) Pub. Date: Jun. 2, 2005

(54) Method for the production of protective layers with dirt and water repelling properties

(75) Inventors: Markus Oles, Hattingen (DE); Edwin Nun, Billerbeck (DE); Michael Droscher, Dorsten (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Creavis Gesellschaft Fuer, Marl (DE)

(21) Appl. No.: 10/502,804

(22) PCT Filed: Feb. 5, 2003
(86) PCT No.: PCT/EP03/01109

(30) Foreign Application Priority Data
Feb. 7, 2002 (DE) 102 05 007.4

(51) Int. Cl. B32B 9/00; B05D 1/12; B32B 5/16; B05D 3/02

(52) U.S. Cl. 428/447; 427/180; 427/372.2; 427/430.1; 427/427.1; 428/332; 428/429; 428/323

(57) ABSTRACT

The present invention describes a process by which a coating which has dirt- and water-repellant properties can be applied non-permanently to any article. It is usual nowadays for articles to be provided with self-cleaning properties by generating, on the surface of the article, a surface structure made from elevations and depressions which have to have a certain height and a certain separation. This is usually achieved by impressing such structures, or by securing structure-forming particles by means of a carrier system. In this way the surfaces are provided with a permanent self-cleaning surface. If scratching, discoloration, or some other type of damage causes impairment of the surface or surface structure, this cannot be simply removed and reapplied, but instead the article then has to be retreated, freed from the surface structure by a complicated method, or disposed of. In contrast, the inventive coating can be removed again from the articles by relatively simple mechanical means. The inventive coating is also simple to produce, by applying a suspension of an alcohol and structure-imparting particles to the article.

The present invention relates to a process for producing dirt- and water-repellant surface coatings on articles, where hydrophobic particles are applied to the surface of the articles during the coating process, thus creating a surface structure with elevations on the surface of the articles, which has dirt- and water-repellant properties.

The principle of self-cleaning coatings is well known. To achieve good self-cleaning of a surface, the surface has to have a certain roughness, as well as being very hydrophobic. A suitable combination of structure and hydrophobic properties enables even small amounts of water set in motion on the surface to entrain adhering dirt particles and clean the surface (WO 96/04123; U.S. Pat. No. 3,354,022).

According to EP 0 933 388, the prior art for these self-cleaning surfaces is that an aspect ratio >1 and surface energy below 20 mN/m are required. The aspect ratio here is defined as the height of the structure divided by its width. The abovementioned criteria has been achieved in the natural world, for example by the lotus leaf. The plant has a surface formed from a hydrophobic waxy material with elevations whose distance from one another is few μm. Water droplets essentially come into contact only with the peaks of the elevations. There are many descriptions of these water-repellant surfaces in the literature.

Swiss Patent 268 258 describes a process which generates structured surfaces by applying powders, such as kaolin, talc, clay or silica gel. The powders are secured to the surface by oils and resins based on organosilicon compounds (Examples 1-6).

EP 0 909 747 teaches a process for generating a self-cleaning surface. The surface has hydrophobic elevations with a height of from 5 to 200 μm. This surface is produced by applying a dispersion of powder particles and an inert material in a siloxane solution, and then curing. The structure-forming particles are thus secured to the substrate by an auxiliary medium.

WO 00/58410 comes to the conclusion that it is technically possible to make the surfaces of articles artificially self-cleaning. The surface structures needed for this purpose and composed of elevations and depressions have a separation between the elevations of the surface structures in the range from 0.1 to 200 μm, and an elevation height in the range from 0.1 to 100 μm. The materials used for this purpose have to be composed of hydrophobic polymers or of lastingly hydrophobicized material. Release of the particles from the carrier matrix has to be prevented.

The use of hydrophobic materials, such as perfluorinated polymers, for producing hydrophobic surfaces is known. A further development of these surfaces consists in structuring the surfaces in the μm to nm range. U.S. Pat. No. 5,599,489 discloses a process in which a surface can be rendered particularly repellant by bombardment with particles of appropriate size, followed by perfluorination. Another process is described by H. Saito et al. in “Surface Coatings International”, 4, 1997, pp. 168 et seq. Here, particles made from fluoropolymers are applied to metal surfaces, whereupon the resultant surfaces can markedly reduce the wettability with respect to water, with a considerably reduced tendency toward icing.

This principle has been borrowed from the natural world. Small contact surfaces lower the level of Van der Waals interaction responsible for adhesion to flat surfaces with low surface energy. For example, the leaves of the lotus plant have elevations made from a wax, and these reduce the area of contact with water.

Processes for producing these structured surfaces are likewise known. Besides the use of a master structure to mold these structures in full detail by injection molding or embossing processes, there are also known processes which utilize the application of particles to a surface (U.S. Pat. No. 5,599,489).

In recent times attempts have also been made to provide self-cleaning surfaces on textiles. It has been found that self-cleaning surfaces can be generated on textiles by applying Aerosils. A solvent is used here to incorporate the Aerosils into the polymer matrix of the textile fiber.

DE 101 18 348 describes polymeric fibers having self-cleaning surfaces, where the self-cleaning surface is obtained by the action of a solvent comprising structure-forming particles, using the solvent to solvate the surface of the polymer fibers, causing the structure-forming particles to adhere to the solvated surface, and removing the solvent. The disadvantage of this process is that during processing of the polymer fibers (spinning, knitting, etc.) the structure-forming particles, and thus the structure on which the self-cleaning surface is based, can become damaged or under certain circumstances even be lost entirely, with concomitant loss of the self-cleaning effect.

DE 101 18 346 describes textile sheets with self-cleaning and water-repellant surface, composed of at least one synthetic and/or natural textile base material A and of an artificial, at least to some extent hydrophobic surface with elevations and depressions made from particles which have been firmly bonded to the base material A without adhesives, resins, or coatings. These are obtained by treating the base material A with at least one solvent which comprises the undissolved particles, and removing the solvent, whereupon at least some of the particles are securely bonded to the surface of the base material A. However, the disadvantage of this process stems from very complicated finishing of the textile surfaces. With this process it is necessary for the solvent to be precisely matched to the base material for the textiles. However, clothing generally comprises mixed fabrics, adding complication to this matching process. If matching of the solvents is not precise, the result can be damage to parts of the clothing. Treatment of the textile surfaces therefore has to precede tailoring.

A disadvantage of all of these coatings is that their application to the articles is permanent, and it is therefore difficult to remove and reapply them if scratching, discoloration, or some other type of damage adversely affects the surface or surface structure. In the event of these adverse effects, the article either has to be retreated, or freed from the surface structure by a complicated method, or disposed of.

WO 00/58410 describes a process for producing removable coatings with dirt- and water-repellant properties, these being produced by spray-application of hydrophobic alcohols, such as nonacosan-10-ol, or of alkanediols, such as nonacosane-5,10-diol, or of waxes. These coatings can be removed from the objects by severe mechanical forces, e.g. scratching, brushing, or high-pressure water treatment, or by treatment with water comprising detergents which remove some of the structure-formers. A disadvantage here is the severe forces needed for mechanical removal of the coating, always carrying the risk that when the coating is removed the article itself will also be adversely affected. Depending on the nature of the article, treatment with water which comprises detergents can likewise have an adverse effect on the article.

DE 101 35 157 describes a process for the coating of textiles during a dry-cleaning procedure, in which structure-forming particles are added to the cleaning agent. The cleaning agents proposed are relatively aggressive organic solvents, e.g. trichloroethylene, the use of these solvents leading to mechanical anchoring of the particles to the structure of the textiles, a process which can have an adverse effect on the article to be coated.

An object of the present invention was therefore to provide a process which can produce dirt- and water-repellant surface coatings on articles and which can also provide articles made from sensitive materials with a coating with is relatively stable but can be removed using simple means.

Surprisingly, it has been found that it is possible to obtain coatings which have dirt- and water-repellant properties and are relatively stable when sprayed with water, but can also be removed by simple means, by applying, to the surface of an article, suspensions which comprise an alcohol and, for example, hydrophobic structure-forming silica particles, and then removing the alcohol.

The present invention therefore provides a process as claimed in claim 1 for producing removable dirt- and water-repellant surface coatings on articles, where during the coating process hydrophobic particles are applied to the surface of the articles, thus generating a surface structure with elevations on the surface of the articles, which has dirt- and water-repellant properties, which comprises suspending hydrophobic particles, preferably hydrophobic silica, in an alcohol and applying this suspension to at least one surface of an article, and then removing the alcohol.

The present invention also provides articles which on at least one surface have been provided with a water- and dirt-repellant coating produced by a process as claimed in at least one of claims 1 to 10.

The present invention also provides a non-permanent protective coating with water- and dirt-repellant properties for articles, where the protective coating can be removed from the surface of the article by impact from liquid droplets with a momentum greater than 12 mNs.

The present invention also provides the use of the process as claimed in any of claims 1 to 10 for the coating of articles which have high exposure to dirt and water, in particular for the outdoor sector, ski sports, alpine sports, motor sports, motorcycle sports, motorcross sports, or sailing sports, and textiles for the leisure sector, and also for the coating of technical textiles selected from tenting, awnings, umbrellas, table covers, cabriolet covers, and workwear, and the use of the process as claimed in any of claims 1 to 10 in impregnation sprays.

The present invention describes a process which can produce removable dirt- and water-repellant coatings.

The invention has the advantage that articles can be provided in a simple manner with a non-permanent dirt- and water-repellant layer, the selection of articles which can be provided with this coating being determined merely by compatibility with alcohols.

In contrast with processes of the prior art, the inventive coating process using a removable dirt-repellant layer is relatively gentle, since during application only alcohols are used as a basis of the suspension, and since the removal of the coating can be achieved using water and a slightly elevated pressure but specifically without any use of detergents.

The coating produced by the process of the invention is non-permanent and is therefore particularly suitable as a protective coating for new articles prior to soiling, e.g. during transport or in sales areas. The protective coatings of the invention can be removed without difficulty by exposure to liquid droplets at an elevated pressure.

The process for producing removable dirt- and water-repellant surface coatings on articles, where during the coating process hydrophobic particles are applied to the surface of the articles, thus generating a surface structure with elevations on the surface of the articles, which has dirt- and water-repellant properties, comprises suspending hydrophobic particles in an alcohol and applying this suspension to at least one surface of an article, and then removing the alcohol.

Alcohols which may be used are any of the alcohols liquid at room temperature, in particular methanol, ethanol, and isopropanol. Very particular preference is given to ethanol used as alcohol. However, it can also be advantageous for the suspension to comprise a mixture of alcohols.

The application of the suspension to at least one surface of the article may take place in a manner known to the skilled worker. The suspension is preferably applied by dipping the article into the suspension and then permitting droplets of the suspension to run off, or by spray-application of the suspension to the article. Surprisingly, spray-application of the suspension in particular can generate particularly durable coatings which have relatively low susceptibility to scratching and abrasion, in particular on polymer surfaces. A possible reason for this is that alcohol facilitates charge equilibration on polymer surfaces, leading to a reduction in the level of local electrical fields. By virtue of this reduction, the particles can become anchored more easily within the surface-roughness features which are always present. During the spraying procedure, the kinetic energy of the particles increases the firmness with which the particles become embedded into the surface-roughness features of the polymer matrix. A sprayer preferably used for spray-application of the suspension is a die with a diameter of from 0.05 to 2 mm, preferably with a diameter of from 0.1 to 0.9 mm. A pressure of from 1 to 10 bar is preferably used to spray the suspension.

The alcohol is removed by evaporation or volatilization, and this evaporation or volatilization may be accelerated by using elevated temperatures or by using subatmospheric pressure or vacuum.

Particles which may be used are those which comprise at least one material selected from silicates, minerals, metal oxides, metal powders, silicas, pigments, and polymers. The particles may particularly preferably be silicates, doped silicates, minerals, metal oxides, aluminum oxide, silicas, or fumed silicates, Aerosils, or pulverulent polymers, e.g. spray-dried and agglomerated emulsions or cryogenically milled PTFE. Silicas are particularly preferably used as hydrophobic particles.

It is preferable to use particles whose average diameter is from 0.02 to 100 μm, particularly preferably from 0.01 to 50 μm, and very particularly preferably from 0.1 to 30 μm. However, other suitable particles are those formed when primary particles combine to give agglomerates or aggregates whose size is from 0.2 to 100 μm.

It can be advantageous for the particles used to have a structured surface. It is preferable to use particles whose surface has an irregular fine structure in the nanometer range, i.e. a structure in the range from 1 to 1000 nm, preferably from 2 to 750 nm, and very particularly preferably from 10 to 100 nm. A fine structure means structures whose heights, widths, and separations are within the ranges mentioned. Particles of this type preferably comprise at least one compound selected from fumed silica, precipitated silicas, aluminum oxide, silicon dioxide, fumed and/or doped silicates, and pulverulent polymers.

The hydrophobic properties of the particles may be present inherently by virtue of the material used for the particles, as is the case with polytetra-fluoroethylene (PTFE) for example. However, it is also possible to use hydrophobic particles whose hydrophobic properties derive from a suitable treatment, e.g. particles treated with at least one compound from the group consisting of the alkylsilanes, the fluoroalkylsilanes, and the disilazanes. Particularly suitable particles are hydrophobicized fumed silicas, known as Aerosils. Examples of hydrophobic particles are Aerosil VPR 411 or Aerosil R 8200. Examples of particles which can be hydrophobicized by treatment with perfluoroalkylsilane followed by heat-conditioning are Aeroperl 90/30, Sipernat silica 350, aluminum oxide C, zirconium silicate, vanadium-doped or VP Aeroperl P 25/20.

It is preferable that the inventive suspension comprises from 0.1 to 10% by weight, preferably from 0.5 to 5% by weight, very particularly preferably from 1 to 2.5% by weight, of hydrophobic particles in the alcohol. The coatings produced by the process of the invention are dirt- and water-repellant, and preferably have elevations formed by the particles and, where appropriate, the fine structure of the particles, with an average height of from 50 nm to 25 μm, and with an average separation of from 50 nm to 25 μm, preferably with an average height of from 100 nm to 10 μm, and/or with an average separation of from 100 nm to 10 μm, and very particularly preferably with an average height of from 100 nm to 4 μm, and/or with an average separation of from 100 nm to 4 μm. It is very particularly preferable for the inventive coatings to have elevations with an average height of from 0.3 to 1 μm and with an average separation of from 0.3 to 1 μm. For the purposes of the present invention, the average separation of the elevations is the distance of the highest elevation of an elevation to the next highest elevation. If this elevation has the shape of a cone, the tip of the cone is the highest elevation of the elevation. If the elevation is a rectangular parallelepiped, the uppermost surface of the parallelepiped is the highest elevation of the elevation. The average width of the elevations is preferably from 50 nm to 25 μm, with preference from 100 nm to 10 μm, and very particularly preferably from 0.3 to 1 μm. The average width of the elevations is measured at half of the height of the elevations, and averaged across the smallest and the largest width. The average width of a cone or of a cylinder is therefore the diameter of the cylinder or cone at half its height. The resultant average width for a cube is the average of the length of the face plus the length of the face diagonals. The surfaces produced by the process of the invention preferably have a contact angle for water greater than 145°, preferably greater than 150°, particularly preferably greater than 155°, and very particularly preferably greater than 160°.

The inventive coatings may be removed from the coated article in a simple manner by a water jet. It is preferable for the coating to be removable from the article by means of a water jet whose momentum is greater than 12 mNs and less than 60 mNs, preferably less than 30 mNs and greater than 15 mNs. No detergents are needed in the water in order to remove the coating.

The process of the invention can produce articles which on at least one surface have been provided with a water- and dirt-repellant coating. The articles or the surfaces to be coated may be composed of a very wide variety of substances, e.g. metal, plastic, polymer, wood, ceramic, or glass.

The inventive protective coating for articles, which has water- and dirt-repellant properties and which can be produced by the process of the invention, for example, may be removed in a simple manner from the surface of the article using liquid droplets which impact the surface with by treatment with a momentum greater than 12 mNs. This value corresponds to the momentum of a raindrop falling toward the earth at twice the velocity normally encountered in the natural world. The protective coating therefore resists normal rain.

Examples of uses of the inventive protective coating are for the protection of articles such as means of transport, e.g. ships or aircraft, or motor vehicles, e.g. cars, buses, trucks, motor cycles, or pedal cycles, or machine tools, from soiling during transport and in sales areas.

The process of the invention may be used for the coating of articles which have high exposure to dirt and water, in particular for the outdoor sector, ski sports, alpine sports, motor sports, motorcycle sports, motorcross sports, sailing sports, and textiles for the leisure sector, and also for the coating of technical textiles selected from tenting, awnings, umbrellas, table covers, cabriolet covers, and workwear.

The process of the invention may also be used in impregnation sprays. These sprays are used to provide removable dirt- and water-repellant coatings for garden furniture, car wheel rims, car coatings, showers, tiles, sanitary surfaces in general, laundries, and the like, for example. An active ingredient preferably present in this impregnating spray is a suspension of hydrophobic particles in an alcohol, as described above.

The process of the invention, and its use, are described by way of example below, but with no intention to limit the invention thereto.

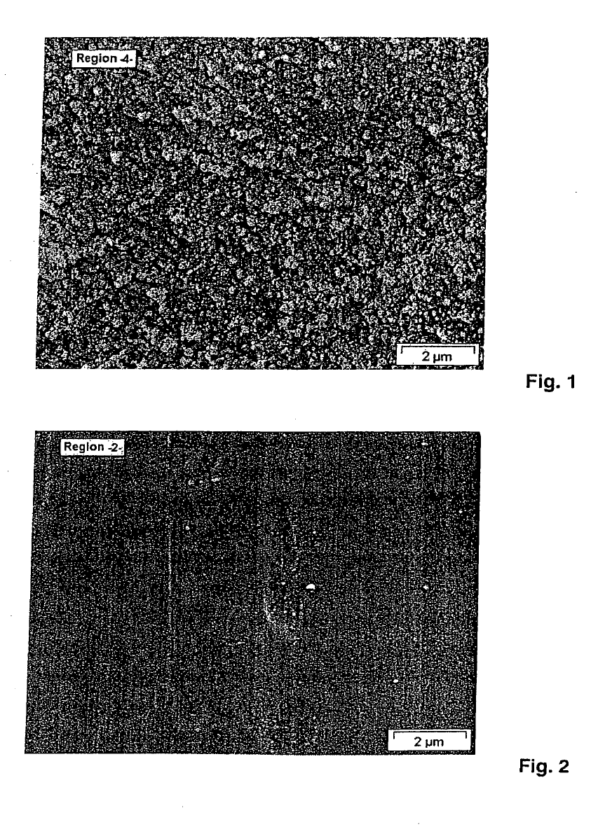

The process of the invention and the inventive coating are further illustrated using FIGS. 1 to 4, but are not restricted thereto.

FIG. 1 shows a scanning electron micrograph of a PET film which has been dipped, as in Example 1, into a suspension made from 1% of Aerosil R8200 in ethanol.

FIG. 2 shows a micrograph of the same article which has been freed from the coating, using a water jet with a momentum of 15 mNs, as in Example 2. It is apparent that the coating could be removed completely from the article without adversely affecting the same.

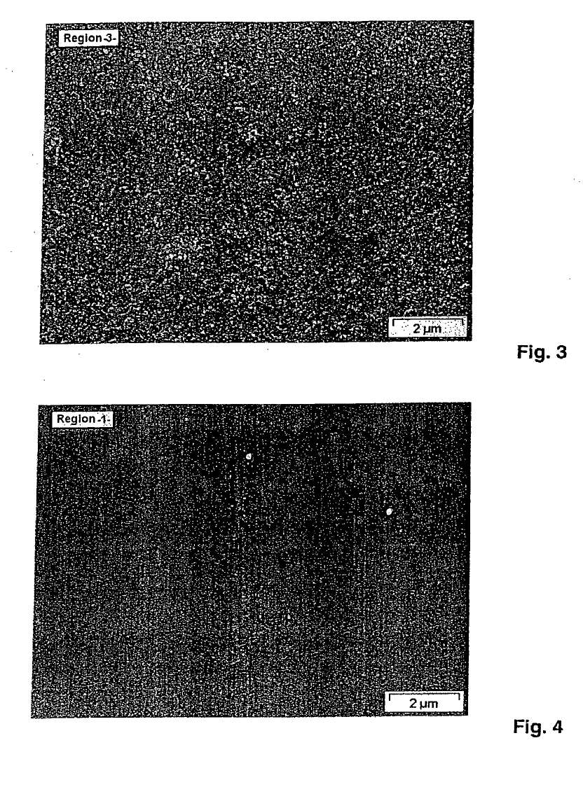

FIG. 3 shows a scanning electron micrograph of a PET film which, as in Example 3, has been provided with an inventive coating.

FIG. 4 shows a micrograph of the same article which has been freed from the coating, using a water jet with a momentum of 20 mNs, as in Example 4. It is apparent that the coating could be removed completely from the article without adversely affecting the same.

### EXAMPLE 1

A film made from polyethylene terephthalate (PET film) is dipped into a suspension made from 1% Aerosil R8200 (Degussa AG) in ethanol. After droplets of the suspension had been allowed to run off, the resultant coating was dried. Self-cleaning experiments were carried out, whereupon it was apparent that carbon black applied to the coating could be washed off by spraying the coating with water. The contact angle measured for a water droplet on the surface was 153°, and at an angle of 4° from horizontal, a 60 μl water droplet ran off from the plane. No change in the coating could be observed as a result of spraying with water (FIG. 1).

### EXAMPLE 2

The coated article from Example 1 was freed from the coating, using a water jet. The momentum of the water jet was 15 mNs. After the water-jet treatment, it could be observed that the coating had been removed completely (FIG. 2).

### EXAMPLE 3

A PET film, as in Example 1, is sprayed with the contents of a spray can which comprises a suspension made from 1.5% of hydrophobic silica (Aerosil R8200, Degussa AG) in ethanol and a propellant (Drivosol®, producer Degussa AG) at a pressure of 3.2 bar. The diameter of the die of the spray can was 0.5 mm. Again, self-cleaning experiments were carried out, whereupon it was apparent that carbon black applied to the coating could be washed off by spraying the coating with water. The roll-off angle for a 60 μl droplet was 0.2° and the contact angles (advancing and receding angle) were 160.2° and 160°. No change in the coating could be observed as a result of spraying with water (FIG. 3).

### EXAMPLE 4

Attempts were made to remove the coating from the sheet of Example 3, as in Example 2. It was apparent that with the parameters selected in Example 2 it was impossible to remove the coating. The coating could not be completely removed from the sheet until the momentum of the water jet reached 20 mNs (FIG. 4).

1. A process for producing removable dirt- and water-repellent surface coatings on an article comprising:
suspending hydrophobic particles made from silicas whose surface has an irregular fine structure in the nanometer range and which have been formed by combination from primary particles to give agglomerates or aggregates whose size is from 0.2 to 100 μm, in an alcohol to form a suspension;
applying the suspension to at least one surface of the article to create a surface structure with elevations, formed by the particles and by the fine structure of the particles on at least one surface of an article; and then
removing the alcohol
wherein dirt and water are removed from the surface of the article by impact of liquid droplets with a momentum greater than 12 mNs.

2. The process as claimed in claim 1, wherein the alcohol comprises methanol, ethanol, or isopropanol.

3. The process as claimed in claim 1, wherein the suspension is applied to at least one surface of an article by dipping the article into the suspension.

4. The process as claimed in claim 1, wherein the suspension is applied to at least one surface of an article by spray-application of the suspension to the article.

5. The process as claimed in claim 1, wherein the average diameter of the hydrophobic particles is from 0.1 to 30 μm.

6. The process as claimed in claim 1, wherein
the hydrophobic particles are provided with hydrophobic properties through treatment with at least one compound selected from the group consisting of the alkylsilanes, fluoroalkylsilanes, and disilazanes.

7. The process as claimed in claim 1, wherein
said article comprises metal, polymer, wood, ceramic, or glass.

8. The process as claimed in claim 1, wherein the
suspension comprises from 0.5 to 5% by weight of hydrophobic particles in alcohol.

9. The process as claimed in claim 1, wherein
said article has high exposure to dirt and water.

10. An article which, on at least one surface, has been provided with a water- and dirt-repellent coating produced by a process as claimed in claim 1.

11. The article as claimed in claim 10, wherein the surface has elevations, formed by the particles and by the fine structure of the particles, with an average height of from 50 nm to 25 μm and an average separation of from 50 nm to 25 μm.

12. An impregnating spray which comprises a suspension of hydrophobic particles comprising silica whose surface has an irregular fine structure in the nanometer range and which has been formed by combination of primary particles to give agglomerates or aggregates whose size is from 0.2 to 100 μm, in an alcohol.
